(19) United States
(12) Patent Application Publication
(10) Pub. No.: US 2024/0014897 A1
(43) Pub. Date: Jan. 11, 2024

(54) OPTICAL COMMUNICATION MONITORING DEVICE

(71) Applicant: NIPPON TELEGRAPH AND TELEPHONE CORPORATION, Tokyo (JP)

(72) Inventors: Sei KOU, Musashino-shi, Tokyo (JP); Tomoya HATANO, Musashino-shi, Tokyo (JP); Hirotaka UJIKAWA, Musashino-shi, Tokyo (JP); Yuka OKAMOTO, Musashino-shi, Tokyo (JP)

(73) Assignee: NIPPON TELEGRAPH AND TELEPHONE CORPORATION, Tokyo (JP)

(21) Appl. No.: 18/025,370

(22) PCT Filed: Sep. 11, 2020
(86) PCT No.: PCT/JP2020/034481

§ 371 Date: Mar. 8, 2023

(51) Int. Cl. H04B 10/077

(52) U.S. Cl. CPC H04B 10/0771

(57) ABSTRACT

An optical sensor (3) is installed in an optical path control device (1) that controls an optical path (2) without using an electrical element. The optical sensor (3) detects an optical signal passing through the optical path (2). A communication state determination unit (5) determines a communication state of the optical path (2) based on detection of the optical signal by the optical sensor (3). A position information reception management unit (10) receives and stores position information of the optical path control device (1). An information arrangement unit (6) collectively converts a determination result of the communication state determination unit (5) and the position information into information. A transmission unit (7) transmits the information.

### DESCRIPTION

### Technical Field

The present disclosure relates to an optical communication monitoring device that monitors a communication state of an optical path control device having no electrical element.

### Background Art

In an optical communication system such as a passive optical network (PON) system, a device has been proposed that specifies a failure section in case where a communication failure occurs in an optical path (see, for example, Patent Literature 1).

Citation List

Patent Literature

Patent Literature 1: JP 2010-171652 A

### SUMMARY OF INVENTION

### Technical Problem

The optical communication system uses an optical path control device such as an optical splitter that branches an optical path, a coupler that concentrates optical paths, or a patch panel that switches optical paths. The optical path control device controls an optical path without using an electrical element, and thus cannot monitor a communication state of the optical path. Therefore, it is difficult to specify a failed optical path in a case where a communication failure occurs, and it takes time to specify the failed optical path. This difficulty is a larger problem in a case where there are many failures or in a case where the failures are scattered in various places.

The present disclosure has been made to solve the above-described problems, and an object thereof is to obtain an optical communication monitoring device that monitors a communication state of an optical path control device having no electrical element and specifies the position of the optical path control device.

### Solution to Problem

An optical communication monitoring device according to the present disclosure includes: an optical sensor that is installed in an optical path control device configured to control an optical path without using an electrical element and detects an optical signal passing through the optical path; a communication state determination unit that determines a communication state of the optical path based on detection of the optical signal by the optical sensor; a position information reception management unit that receives and stores position information of the optical path control device; an information arrangement unit that collectively converts a determination result of the communication state determination unit and the position information into information; and a transmission unit that transmits the information.

### Advantageous Effects of Invention

According to the present disclosure, it is possible to monitor a communication state of an optical path control device having no electrical element and specify the position of the optical path control device.

### BRIEF DESCRIPTION OF DRAWINGS

FIG. 1 is a diagram illustrating an optical communication system according to a first embodiment.

FIG. 2 is a diagram illustrating an optical communication monitoring device according to the first embodiment.

FIG. 3 is a diagram illustrating the optical communication monitoring device according to the first embodiment.

FIG. 4 is a diagram illustrating an optical communication monitoring device according to a second embodiment.

### DESCRIPTION OF EMBODIMENTS

An optical communication monitoring device according to each embodiment will be described with reference to the drawings. The same or corresponding components are denoted by the same reference signs, and repetition of the description may be omitted.

### First Embodiment

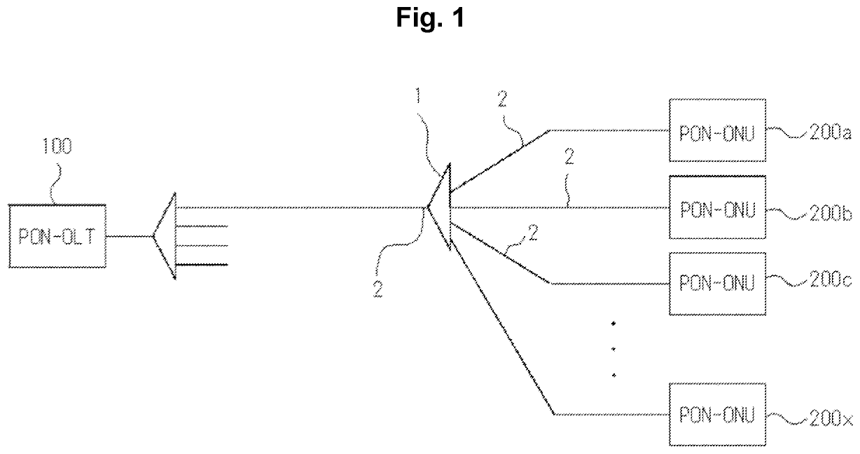

FIG. 1 is a diagram illustrating an optical communication system according to a first embodiment. This optical communication system is a passive optical network (PON) system. A master station device 100 is connected to a plurality of slave station devices 200a to 200x via optical paths, and performs optical communication with each of the plurality of slave station devices 200a to 200x. The master station device 100 is an optical line termination or optical line terminal (OLT). The slave station devices 200a to 200x are optical network units (ONUs). In the PON system, an optical path control device 1 is a coupler that concentrates a plurality of optical paths 2 each connected to a corresponding one of the plurality of slave station devices 200a to 200x on an optical path 2 connected to the master station device 100. Each of the optical paths 2 is an optical fiber (optical core wire) or the like.

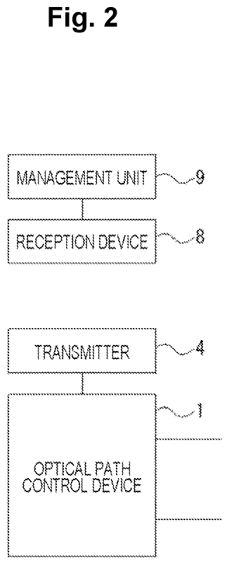

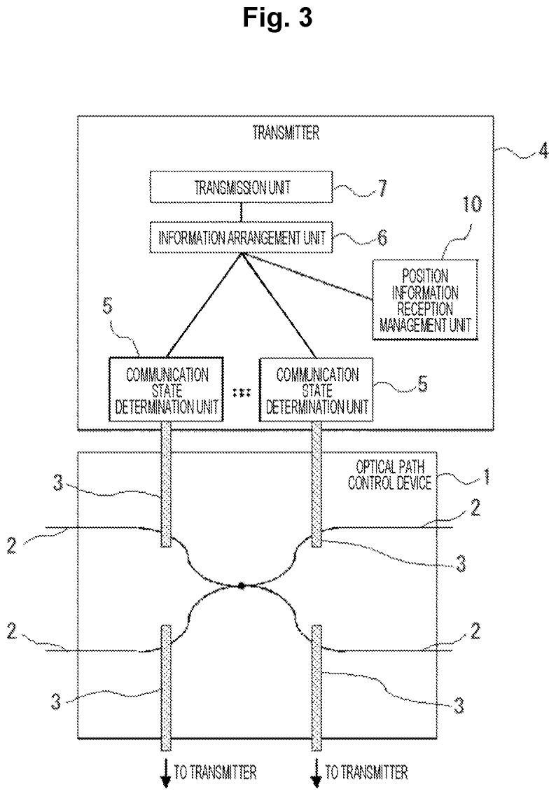

FIGS. 2 and 3 are diagrams illustrating an optical communication monitoring device according to the first embodiment. The optical path control device 1 controls the optical paths 2 without using an electrical element, and is an optical passive component such as an optical splitter that branches an optical path, a coupler that concentrates a plurality of optical paths, or a patch panel that switches light of a plurality of optical paths. For example, the optical path control device 1 is a device that distributes N optical paths to M optical paths (N and M are integers of 1 or more). The optical passive component includes no electrical element and functions without requiring electric power supply.

A plurality of optical sensors 3 are each installed in a corresponding one of the plurality of optical paths 2 of the optical path control device 1. Each of the plurality of optical sensors 3 detects an optical signal passing through the corresponding one of the plurality of optical paths 2. Here, each of the optical sensors 3 is a light receiving element such as a photodiode that converts leakage light of the optical signal passing through the corresponding one of the optical paths 2 into an electrical signal and provides the electrical signal to a transmitter 4 outside the optical path control device 1. The electrical signal does not have to be provided constantly, and may be provided once every certain period in accordance with the transmission frequency of the optical signal. Detection of the optical signal is, for example, detection of the presence or absence or intensity of the optical signal.

The transmitter 4 is a device related to Internet of things (IoT), and includes a plurality of communication state determination units 5, an information arrangement unit 6, a transmission unit 7, and a position information reception management unit 10. Each of the plurality of communication state determination units 5 is provided for a corresponding one of the plurality of optical sensors 3, and determines a communication state of a corresponding one of the plurality of optical paths 2 based on detection of an optical signal by the corresponding one of the plurality of optical sensors 3.

The position information reception management unit 10 receives and stores position information of the optical path control device 1. As the position information reception management unit 10, a functional component capable of receiving position information, such as a GPS, may be used. However, if an expensive GPS is attached to each of a plurality of transmitters 4, the cost increases. Therefore, in order to reduce the cost, an operator may check the position with a GPS device or the like when attaching the transmitter 4, and transmit the position information to the position information reception management unit 10 through wireless communication such as Bluetooth to store the position information.

The information arrangement unit 6 collectively converts the determination results of the plurality of communication state determination units 5 and the position information into information with which the communication state (port state) of each optical path and the position of the optical path control device 1 can be grasped. The transmission unit 7 transmits the information to the outside of the transmitter 4.

A reception device 8 is a device related to IoT, and receives the information transmitted from the transmitter 4 through a communication network such as the Internet. A management unit 9 is a general term for functional units that manage a network. The management unit 9 specifies a failed one of the optical paths 2 based on the information received by the reception device 8. With this configuration, it is possible to monitor a communication state of the optical path control device 1 having no electrical element and specify the position of the optical path control device 1. Therefore, failure handling is easy, which can reduce the operation time.

### Second Embodiment

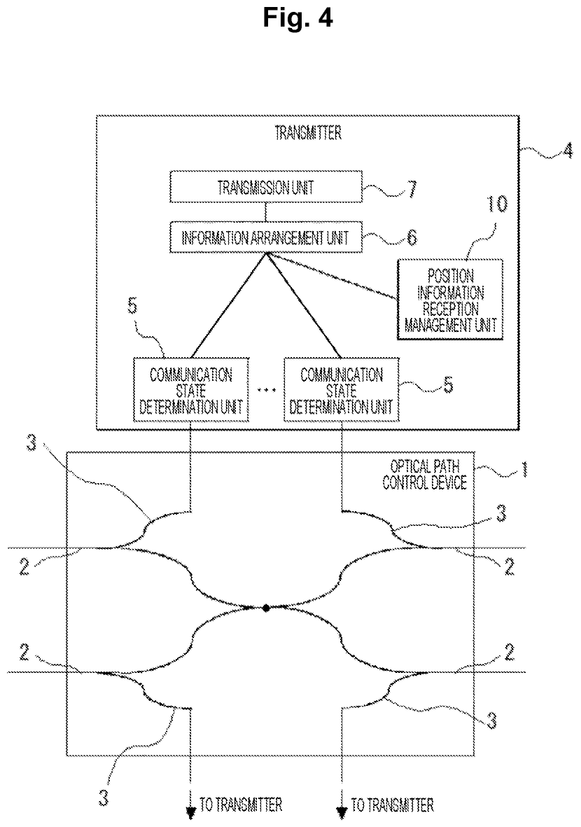

FIG. 4 is a diagram illustrating an optical communication monitoring device according to a second embodiment. Unlike the first embodiment, each of the optical sensors 3 is an optical splitter that branches a part of an optical signal passing through a corresponding one of the optical paths 2 and provides the part of the optical signal to the transmitter 4. The plurality of communication state determination units 5 determine communication states of the plurality of optical paths 2 based on optical signals each branched from a corresponding one of the plurality of optical sensors 3. The configuration of the second embodiment is similar to that of the first embodiment other than this point. With this configuration, effects similar to those of the first embodiment can be obtained. Note that, in order to suppress a reduction in light intensity of a main signal, it is preferable that the branching ratio is not 1:1 but the ratio of an optical signal toward the transmitter 4 is reduced.

Here, if each of the optical sensors 3 also detects an optical signal exiting from the inside of the optical path control device 1, it is difficult to know which of the optical paths 2 a signal has passed through. Therefore, each of the optical sensors 3 needs to detect an optical signal entering the optical path control device 1 from the outside. Therefore, in a case where the optical path control device 1 is a coupler or a splitter, it is preferable to use an optical splitter of the present embodiment as each of the optical sensors 3 rather than a light receiving element of the first embodiment. In a case where the optical path control device 1 is a device having no branch, such as a patch panel, a light receiving element may be used as each of the optical sensors 3.

Note that, in the first and second embodiments, the optical path control device 1 has been described by taking a coupler as an example, but the branching ratio of the coupler is not limited. In addition, even in a case where the optical path control device 1 is not a coupler but an optical switch, the optical communication monitoring device has a configuration similar to that described above. Furthermore, the transmitter 4 is detachable from the optical path control device 1. Even if the transmitter 4 fails or the electric power supply to the transmitter 4 is stopped, a main signal of an optical signal is not affected.

### Reference Signs List

1 Optical path control device
2 Optical path
3 Optical sensor
4 Transmitter
5 Communication state determination unit
6 Information arrangement unit
7 Transmission unit
8 Reception device
9 Management unit
10 Position information reception management unit
100 Master station device
200a to 200x Slave station device

1. An optical communication monitoring device comprising:
an optical sensor that is installed in an optical path control device configured to control an optical path without using an electrical element and detects an optical signal passing through the optical path;
a communication state determination unit that determines a communication state of the optical path based on detection of the optical signal by the optical sensor;
a position information reception management unit that receives and stores position information of the optical path control device;
an information arrangement unit that collectively converts a determination result of the communication state determination unit and the position information into information; and
a transmission unit that transmits the information.

2. The optical communication monitoring device according to claim 1, wherein
the optical path includes a plurality of optical paths,
the optical path control device branches, concentrates, or switches the plurality of optical paths, and
the optical sensor includes a plurality of optical sensors that detect optical signals each passing through at least one of the plurality of optical paths.

3. The optical communication monitoring device according to claim 2, further comprising:
a reception device that receives the information transmitted from the transmission unit; and
a management unit that specifies a failed one of the optical paths based on the information received by the reception device.

4. The optical communication monitoring device according to claim 1, wherein the optical sensor is a light receiving element that converts the optical signal passing through the optical path into an electrical signal and provides the electrical signal to the communication state determination unit.

5. The optical communication monitoring device according to claim 1, wherein the optical sensor is an optical splitter that branches a part of the optical signal passing through the optical path and provides the part of the optical signal to the communication state determination unit.
